(19) United States
(12) Patent Application Publication
(10) Pub. No.: US 2023/0399892 A1
(43) Pub. Date: Dec. 14, 2023

(54) AUTOMATIC ROLLER SHUTTER FOR ANIMALS

(71) Applicant: Dongguan City GeShengMei Industrial Co., Ltd, Dongguan City (CN)

(72) Inventor: Taotao Lei, Dongguan City (CN)

(21) Appl. No.: 18/457,639

(22) Filed: Aug. 29, 2023

(30) Foreign Application Priority Data
Aug. 18, 2023 (CN) 202322237594.5

(51) Int. Cl. E06B 9/72; E06B 9/11

(52) U.S. Cl. CPC E06B 9/72; E06B 9/11; E06B 2009/6827

(57) ABSTRACT

An automatic roller shutter for animals includes a door frame, a roller shutter body, a driving motor, an accumulator, a solar panel, a controller, a display screen and a front housing. The roller shutter body is slidably configured on the door frame, and the driving motor is configured on the door frame and electrically connected with the controller to drive the roller shutter body to retract or extend; the controller is provided with control buttons; a front side of the front housing is provided with a first opening and a second openings, the display screen is exposed through the first opening, and the control buttons are exposed through the second openings; and the solar panel is arranged the front housing. The roller shutter has high integration, compact structure, convenient assembly and transportation.

### FIELD OF THE INVENTION

The present application relates to the technical field of roller shutters, in particular to an automatic roller shutter for animals for animals.

### BACKGROUND OF THE INVENTION

Animals are friends of human beings. People usually keeps some pet animals indoors such as in barns, pens or special cages. However, it's necessary to frequently or regularly keep them outdoors for their health. In the absence of the animal owner, a safety apparatus that can automatically perform these operations instead of the owner is necessary.

Currently, an automatic roller shutter is used as a typical safety apparatus for automatically performing theses operations. Such an automatic roller shutter has a driving motor installed on the door frame, and an external controller is configured to control the driving motor. In addition, an external solar panel and a battery are configured outside the roller shutter, to start the roller shutter by solar power. However, such an automatic roller shutter has low integration of various devices, such as the controller, solar panel and battery mentioned above are independent of the door, which makes the structure of the entire roller shutter not compact, and the parts are easy to lose during the transportation process, and the assembly and transportation are inconvenient.

### SUMMARY OF THE INVENTION

The present invention aims to provide an automatic roller shutter for animals with high integration, compact structure, convenient assembly and transportation.

To achieve the above purpose, an automatic roller shutter for animals of the present invention includes a door frame, a roller shutter body, a driving motor, an accumulator, a solar panel, a controller, a display screen and a front housing. The roller shutter body is slidably configured on the door frame, and the driving motor is configured on a rear side of an upper end of the door frame and electrically connected with the controller to drive the roller shutter body to retract or extend; the front housing is arranged on a front side of the upper end of the door frame; the accumulator and the display screen are electrically connected with the controller and received in the front housing together with the controller, and the controller is provided with a plurality of control buttons; a front side of the front housing is provided with a first opening and a plurality of second openings, the display screen is exposed through the first opening, and each of the control buttons is exposed through each of the second openings; and an upper side of the front housing is provided with a mounting surface, on which the solar panel is arranged to transmit electricity to the accumulator by solar power generation.

In comparison with the prior art, in the automatic roller shutter for animals of the present invention, the front housing is configured on the upper end of the door frame, the accumulator, the display screen and the controller are built in the front housing; furthermore, the first opening and the second openings are provided at the front side of the front housing, to expose the display screen and the control button; moreover, the solar panel is arrange on the mounting surface of the front housing, thus the electronic control part of the entire roller shutter is centrally arranged on the upper end of the door frame, which makes the structure of the product more compact to improve the integration. In production, each part can be first assembled into the front housing, and then the whole front housing together with the parts is installed on the upper end of the door frame as a whole, thus the assembly is more convenient. In addition, transportation is greatly facilitated since the parts are integrated together.

Preferably, the mounting surface is tilted downwards at an angle from a rear side to a front side. In such a way, it's beneficial to drain away the rain to avoid dust accumulation affecting power generation, and also improve the power generation efficiency since the solar panel may receive the sun light at different times at a better angle.

Preferably, a rotating shaft is provided and coaxial with an output end of the driving motor, a connecting rod is provided radially on the rotating shaft, and one end of the connecting rod is connected with an upper end of the roller shutter body to drive the roller shutter body to retract or extend.

Preferably, the automatic roller shutter for animals further includes a sensor electrically connected with the controller, wherein a lower bottom surface of the front housing is provided with a third opening, the sensor is arranged in the front housing and exposed through the third opening, and configured to instruct the controller to stop the driving motor when an object appears below the roller shutter body. In such a way, the animals may be protected to improve use safety.

Preferably, the automatic roller shutter for animals further includes a light sensor electrically connected with the controller, wherein the light sensor is arranged in one of the second openings to detect external light intensity and instruct the controller to control the driving motor to retract or extend the roller shutter body.

Preferably, the automatic roller shutter for animals further includes two main bases and a motor base, the two main bases are respectively installed on the rear side of the upper end of the door frame, and the motor base installed with the driving motor is fixed in one of the main bases.

Preferably, the automatic roller shutter for animals further includes an electrical interface for external power supply connection, wherein the electrical interface is electrically connected with the driving motor, and arranged at the upper end of the door frame. Once the accumulator runs out and the driving motor cannot be driven to rotate, the user can use an external power supply to directly supply power to the driving motor by the electrical interface, so as to ensure normal controls to the roller shutter to improve the use safety.

Preferably, the automatic roller shutter for animals further includes a hand twist generator removably connected to the electrical interface through a plug of a power cord, to supply power to the driving motor. By setting the hand twist generator, the user can manually operate the power generation when the accumulator runs out or a circuit failure is generated, so as to ensure the normal controls of the roller shutter body by the driving motor, which effectively avoids the situation that the roller shutter body cannot be opened or closed.

Preferably, the front housing includes a front cover and a bottom plate, the bottom plate is fixed on the front side of the upper end of the door frame; the accumulator, the controller and the display screen are arranged on the bottom plate, and the front cover is covered in front of the bottom plate. In such a way, the use safety of the electrical components is effectively protected, and the entire roller shutter has good appearance.

Specifically, the front cover includes an outer housing and an inner housing arranged in an integrated form with the outer housing, and an internal space is defined by the bottom plate and the inner housing for receiving the accumulator, the controller and the display screen. By providing the internal space, the accumulator, the controller and the display screen may be pre-installed inside the front cover, and then the front cover and the bottom plate may be installed on the upper end of the door frame as a whole after the assembly of the electrical components is completed, thus improving the convenience of assembly.

Specifically, an isolation groove is formed between the inner housing and the outer housing, and a reinforcing rib connecting with the inner housing and the outer housing is provided in the isolation groove. By providing the isolation slot and reinforcing rib, the overall strength of the front cover can be improved, and the safety of each electrical component inside the front cover can be effectively protected.

Specifically, an inner wall of the inner housing is extended inward to from a support plate, on which the accumulator is arranged. In such a configuration of the support plate, the accumulator can be assembled more firmly and stably.

Specifically, a plurality of connecting members are extended inward from the front cover, a plurality of connecting holes corresponding to the connecting members are provided on an outer side of the bottom plate, and the bottom plate is fixed and connected with the front cover by screws passing through the connecting holes and center holes of the connecting members. In such a way, the appearance of the surface of the front cover is improved since the screws will not be exposed.

### BRIEF DESCRIPTION OF THE DRAWINGS

The accompanying drawings facilitate an understanding of the various embodiments of this invention. In such drawings:

FIG. 1 is a perspective view of an automatic roller shutter for animals according to an embodiment of the invention;

FIG. 2 is another perspective view of an automatic roller shutter for animals according to an embodiment of the invention;

FIG. 3 is an internal structure diagram of a front side of an automatic roller shutter for animals according to an embodiment of the invention;

FIG. 4 is an internal structure diagram of a rear side of an automatic roller shutter for animals according to an embodiment of the invention;

FIG. 5 is an exploded view of an automatic roller shutter for animals according to an embodiment of the invention;

FIG. 6 is a cross section view of an automatic roller shutter for animals according to an embodiment of the invention;

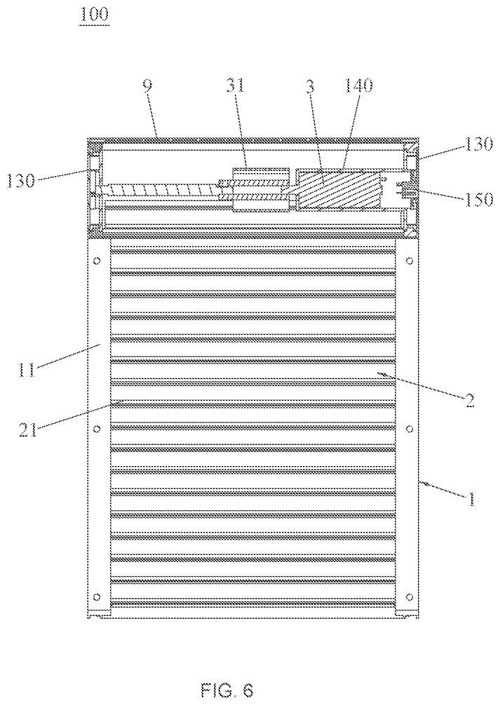

FIG. 7 is a structure diagram of a front housing of an automatic roller shutter for animals according to an embodiment of the invention;

FIG. 8 is an internal structure diagram of a front housing of an automatic roller shutter for animals according to an embodiment of the invention;

FIG. 9 is a structure diagram of a door frame and a roller shutter body of an automatic roller shutter for animals according to an embodiment of the invention; and

FIG. 10 is a structure diagram of an automatic roller shutter for animals which is opened by a hand twist generator.

### DETAILED DESCRIPTION OF ILLUSTRATED EMBODIMENTS

In order to make the purpose, technical solutions and advantages of the present application more clearly understood, the present application will be described in further detail below with reference to the accompanying drawings and embodiments.

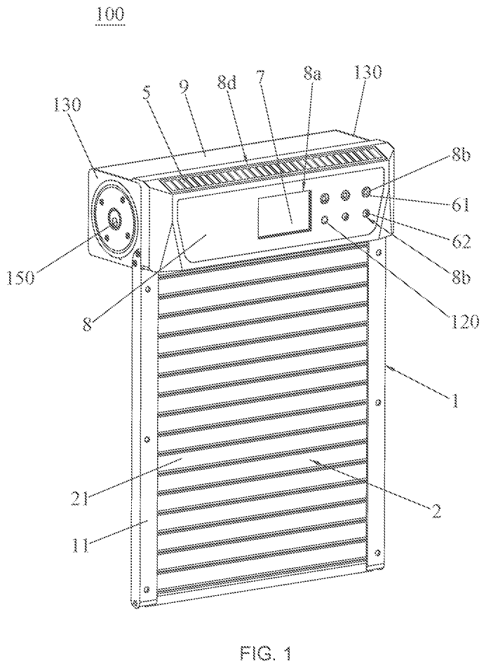

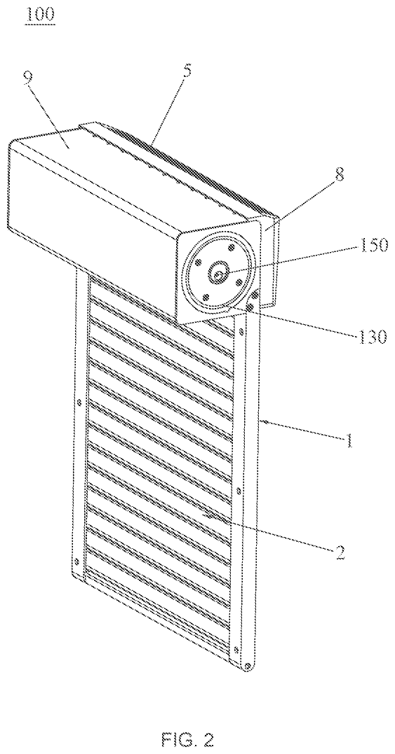

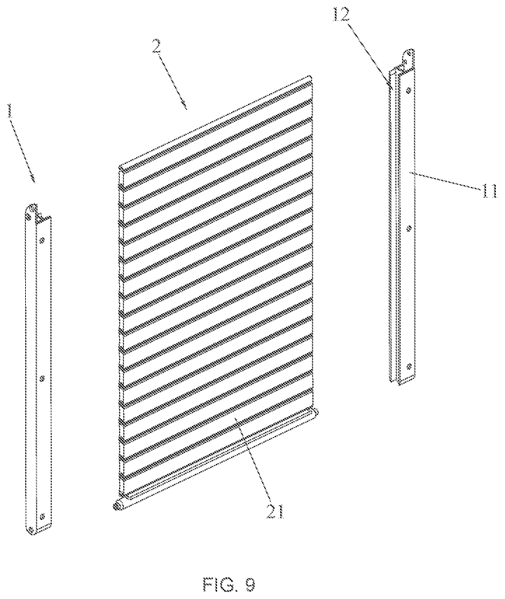

Referring to FIGS. 1-5 and 9, an automatic roller shutter for animals 100 according to the present invention includes a door frame 1, a roller shutter body 2, a driving motor 3, an accumulator 4, a solar panel 5, a controller 6, a display screen 7, a front housing 8 and a rear housing 9. The roller shutter body 2 is configured on the door frame 1 and slidable along the door frame 1 up and down. Specifically, the door frame 1 includes two opposite side frames 11, an inner side of each side frame 11 is respectively provided with a groove 12, and two sides of the roller shutter body 2 are respectively slid into the groove 12 of the two side frames 11. The roller shutter body 2 includes a plurality of slat members 21 mutually hinged to form a retractable roller shutter. The driving motor 3 is arranged on a rear side of an upper end of the door frame 1 and is electrically connected with the controller 6. The output end of the driving motor 3 is coaxially provided with a rotating shaft 31, the rotating shaft 31 is radially provided with a connecting rod 32, and the other end of the connecting rod 32 is connected with the middle shaft of the upper end of the roller shutter body 2. The driving motor 3 rotates to drive the rotating shaft 31 to rotate, so that the rotating shaft 31 drives the roller shutter body 2 to retract or extend by actuating the connecting rod 32. The rear housing 9 is arranged the rear side of the upper end of the door frame 1 and covers the driving motor 3.

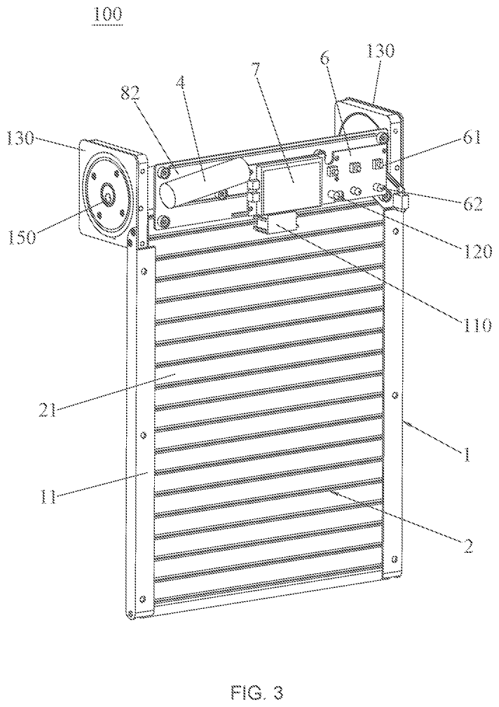

As shown in FIGS. 3, 5 and 7, the front housing 8 is arranged on a front side of the upper end of the door frame 1. The accumulator 4 and the display screen 7 are electrically connected with the controller 6 respectively and received in the front housing 8 together with the controller 6. The accumulator 4 is a rechargeable battery. The controller 6 is provided with a plurality of control buttons 61 and an indicator 62. The front side of the front housing 8 is provided with a first opening 8a and a plurality of second openings 8b, and the second openings 8b are arranged in line. The display screen 7 is exposed through the first opening 8a; and each of the control buttons 61 and the indicator 62 are exposed through the corresponding second opening 8b respectively.

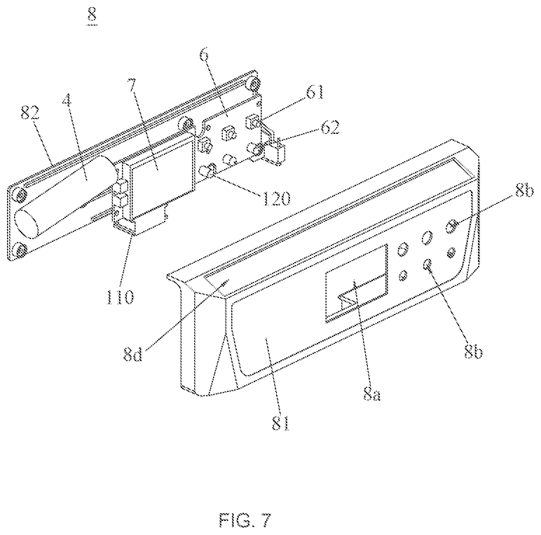

Referring to FIGS. 1 and 7 again, an upper side of the front housing 8 is provided with a mounting surface 8a, on which the solar panel 5 is arranged. The solar panel 5 is electrically connected with the controller 6, to transmit electricity to the accumulator 4 through solar power generation. The mounting surface 8d is tilted downwards at an angle from the rear side to the front side. In such a way, it's beneficial to drain away the rain to avoid dust accumulation affecting power generation, and also improve the power generation efficiency since the solar panel 5 may receive the sun light at different times at a better angle.

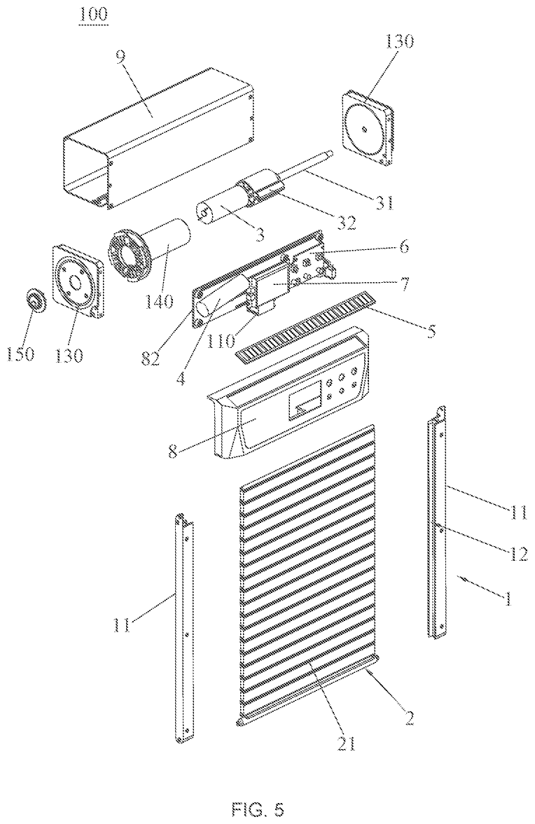

Referring to FIGS. 3 and 5, the automatic roller shutter for animals 100 further includes a sensor 110 electrically connected with the controller 6. A lower bottom surface of the front housing 8 is provided with a third opening 8c, the sensor 110 is arranged in the front housing 8 and exposed through the third opening 8c, so to instruct the controller 6 to stop the driving motor 3 when an object appears below the roller shutter body 2. In such a way, the animals may be protected to improve the use safety. In the present embodiment, the sensor 110 is an infrared sensor 110, which may include an infrared emitter and an infrared receiver. The infrared emitter is configured to emit infrared toward the lower part of the roller shutter body 2, and when one or more animals are located below the roller shutter body 2, the infrared receiver is configured to receive a reflected signal which is then sent to the controller 6, and then the controller 6 controls to stop supplying power to the driving motor 3, and the roller shutter body 2 stops extending. When the animal leaves the roller shutter body 2, no signal is reflected to the infrared receiver, therefore the controller 6 re-supplies power to the driving motor 3 so that the driving motor 3 continues to drive the roller shutter body 2 to extend until it is completely extended.

As shown in FIG. 3, the automatic roller shutter for animals 100 further includes a light sensor 120 electrically connected with the controller 6, and the light sensor 120 is arranged in one of the second openings 8b and configured to detect the light in environment and control the driving motor 3 to retract or extend the roller shutter body 2 by the controller 6. When the light sensor 120 detects a light signal in the morning, the controller 6 instructs the driving motor 3 to open the door, and then the driving motor 3 is energized to drive the roller shutter body 2 to retract. When the light sensor 120 detects no light in the night, the controller 6 instructs the driving motor 3 to close the door, and then the driving motor 3 is energized to drive the roller shutter body 2 to extend. In addition, the automatic roller shutter for animals 100 may further include a temperature and humidity sensor, a rain sensor, an infrared sensor, a microwave sensor, a wind speed sensor, a voice control sensor and/or a programmable timer, to control the driving motor 3 to drive the roller shutter body 2 to retract or extend.

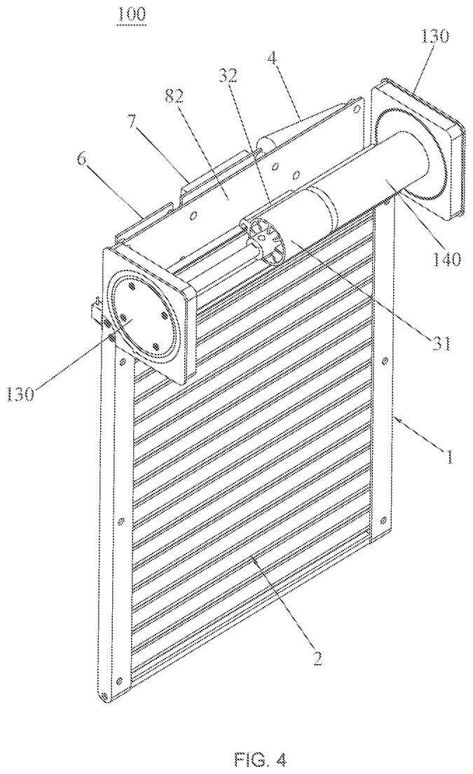

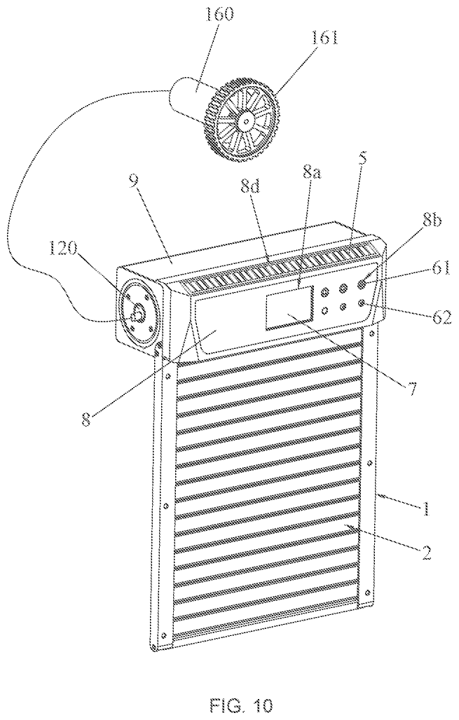

Referring to FIGS. 4, 5 and 10, the automatic roller shutter for animals 100 may further include two main bases 130 and a motor base 140, the two main bases 130 are respectively installed on left and right sides of the upper end of the door frame 1, the motor base 140 is fixed in one of the main bases 130, and the driving motor 3 is installed in the motor base 140 for protection. The automatic roller shutter for animals 100 may further include an electrical interface 150 electrically connected with the driving motor 3 for external power supply connection, and the electrical interface 150 is arranged at the upper end of the door frame. Specifically, the electrical interface 150 is configured at the outer side of the main base 130 that is near the driving motor 3, and the central axis of the electrical interface 150 is coaxial with the central axis of the motor base 140. Once the accumulator 4 runs out and the driving motor 3 cannot be driven to rotate, the user can use an external power supply to directly supply power to the driving motor 3 by the electrical interface 150, so as to ensure normal controls to the roller shutter to improve the use safety. The automatic roller shutter for animals 100 further includes s a hand twist generator 160, which is connected to the electrical interface 150 through the plug of the power cord, so as to supply power to the driving motor 3. The hand twist generator 160 is provided with a rotary knob 161, by which the hand twist generator 160 may be controlled to turn on or turn off the electricity generation. In addition, the current direction of the hand twist generator 160 can be changed by clockwise or counterclockwise twisting, for example, positive current is generated when twisting clockwise, to drive the driving motor 3 to retract the roller shutter body 2; while negative current is generated when twisting counterclockwise, to drive the driving motor 3 to extend the roller shutter body 2. Therefore, by setting the hand twist generator 160, the user can manually operate the power generation when the accumulator 4 runs out or a circuit failure is generated, so as to ensure the normal controls of the roller shutter body 2 by the driving motor 3, which effectively avoids the situation that the roller shutter body 2 cannot be opened or closed.

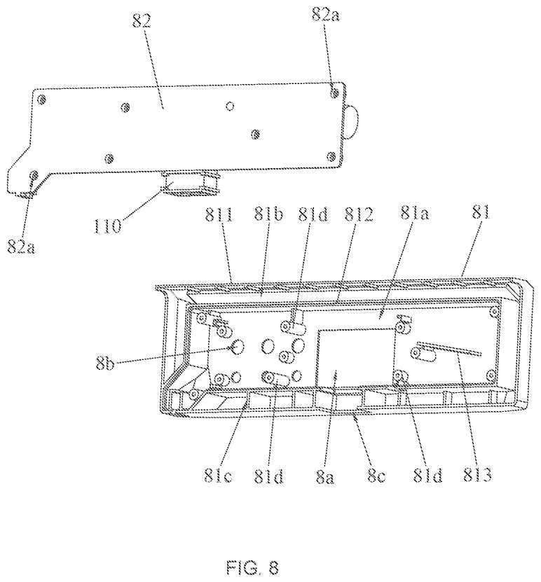

As shown in FIGS. 1, 3, 5, 7 and 8, the front housing 8 includes a front cover 81 and a bottom plate 82, and the bottom plate 82 is fixed on the front side of the upper end of the door frame 1. The accumulator 4, the controller 6 and the display screen 7 are arranged on the bottom plate 82, and the front cover 81 is covered in front of the bottom plate 82. In such a way, the use safety of the electrical components is effectively protected, and the entire automatic roller shutter for animals 100 has good appearance. In particular, the front cover 81 includes an outer housing 811 and an inner housing 812 arranged in an integrated form within the outer housing 811, and the bottom plate 82 and the inner housing 812 enclose an internal space 81a for accommodating the accumulator 4, the controller 6 and the display screen 7. By providing the internal space 81a, the accumulator 4, the controller 6 and the display screen 7 may be pre-installed inside the front cover 81, and then the front cover 81 and the bottom plate 82 may be installed on the upper end of the door frame 1 as a whole after the assembly of the electrical components is completed, thus improving the convenience of assembly. Specifically, an isolation groove 81b is formed between the inner housing 812 and the outer housing 811, and a reinforcing rib 81c is arranged in the isolation groove 81b and connected the inner housing 812 and the outer housing 811. By providing the isolation slot 81b and reinforcing rib 81c, the overall strength of the front cover 81 can be improved, and the safety of each electrical component inside the front cover 81 can be effectively protected. The inner wall of the inner housing 812 is extended inward to form a support plate 813 which is inclined at an angle, and the accumulator is arranged on the support plate 813. In such a configuration of the support plate 813, the accumulator 4 can be assembled more firmly and stably. A plurality of connecting members 81d are extended inward from the front cover 81, a plurality of connecting holes 82a corresponding to the connecting members 81d are provided on an outer side of the bottom plate 82, and the bottom plate 82 is fixed and connected with the front cover 81 by screws passing through the connecting holes 82a and center holes of the connecting members 81d. In such a way, the appearance of the surface of the front cover 81 is improved since the screws will not be exposed.

When the roller shutter body 2 is needed to be retracted, the controller 6 instructs to drive the driving motor 3 according to a signal, and then the rotating shaft 31 is driven to rotate by the driving motor 3, accordingly, the connecting rod 32 is driven to rotate around the central axis of the rotating shaft 31, so that the roller shutter body 2 moves upward along the groove 12 of the door frame 1 to retract up. On the contrary, when three is a need to extend the roller shutter body 2, it is only necessary to control the driving motor 3 to rotate reversely so that the roller shutter body 2 may be extended and moves down along the groove 12.

When the accumulator 4 runs out, it is only necessary to insert the plug of the power cord of the hand twist generator 160 into the electrical interface 150, and then manually twist the hand twist generator 160, and the driving motor 3 may be directly driven. When the hand twisting generator 160 is rotated clockwise, a positive current is generated, and the driving motor 3 drives the roller shutter body 2 to extend; when the hand twisting generator 160 is rotated counterclockwise, a negative current is generated, and the driving motor 3 drives the roller shutter body 2 to retract.

Compared with the prior art, in the automatic roller shutter for animals of the present invention, the front housing is configured on the upper end of the door frame, the accumulator 4, the display screen 7 and the controller 6 are built in the front housing 8; furthermore, the first opening 8a and the second openings 8b are provided at the front side of the front housing 8, to expose the display screen 7 and the control button 61; moreover, the solar panel 5 is arrange on the mounting surface 8d of the front housing 8, thus the electronic control part of the entire roller shutter 100 is centrally arranged on the upper end of the door frame 1, which makes the structure of the product more compact to improve the integration. In production, each part can be first assembled into the front housing 8, and then the whole front housing 8 together with the parts is installed on the upper end of the door frame 1 as a whole, thus the assembly is more convenient. In addition, transportation is greatly facilitated since the parts are integrated together.

The structure and control principle of the controller 6 related to the automatic roller shutter for animals 100 of the present invention are well known to persons ordinarily skilled in the art, which will not be explained in detail here.

The above-mentioned embodiments only denote several embodiments of the present application, and the descriptions thereof are relatively specific and detailed, but should not be construed as limiting the scope of the patent application. It should be pointed out that for those skilled in the art, several modifications and improvements can be made without departing from the concept of the present application, which all belong to the protection scope of the present application. Therefore, the scope of protection of the patent of the present application shall be subject to the appended claims.

What is claimed is:

1. An automatic roller shutter for animals, comprising: a door frame, a roller shutter body, a driving motor, an accumulator, a solar panel, a controller, a display screen and a front housing,
wherein the roller shutter body is slidably configured on the door frame, and the driving motor is configured on a rear side of an upper end of the door frame and electrically connected with the controller to drive the roller shutter body to retract or extend; the front housing is arranged on a front side of the upper end of the door frame; the accumulator and the display screen are electrically connected with the controller and received in the front housing together with the controller, and the controller is provided with a plurality of control buttons; a front side of the front housing is provided with a first opening and a plurality of second openings, the display screen is exposed through the first opening, and each of the control buttons is exposed through each of the second openings; and an upper side of the front housing is provided with a mounting surface, on which the solar panel is arranged to transmit electricity to the accumulator by solar power generation.

2. The automatic roller shutter for animals according to claim 1, wherein the mounting surface is tilted downwards at an angle from a rear side to a front side.

3. The automatic roller shutter for animals according to claim 1, wherein a rotating shaft is provided and coaxial with an output end of the driving motor, a connecting rod is provided radially on the rotating shaft, and one end of the connecting rod is connected with an upper end of the roller shutter body to drive the roller shutter body to retract or extend.

4. The automatic roller shutter for animals according to claim 1, further comprising a sensor electrically connected with the controller, wherein a lower bottom surface of the front housing is provided with a third opening, the sensor is arranged in the front housing and exposed through the third opening, and configured to instruct the controller to stop the driving motor when an object appears below the roller shutter body.

5. The automatic roller shutter for animals according to claim 1, further comprising a light sensor electrically connected with the controller, wherein the light sensor is arranged in one of the second openings to detect external light intensity and instruct the controller to control the driving motor to retract or extend the roller shutter body.

6. The automatic roller shutter for animals according to claim 1, further comprising two main bases and a motor base, the two main bases are respectively installed on the rear side of the upper end of the door frame, and the motor base installed with the driving motor is fixed in one of the main bases.

7. The automatic roller shutter for animals according to claim 1, further comprising an electrical interface for external power supply connection, wherein the electrical interface is electrically connected with the driving motor, and arranged at the upper end of the door frame.

8. The automatic roller shutter for animals according to claim 7, further comprising a hand twist generator removably connected to the electrical interface through a plug of a power cord, to supply power to the driving motor.

9. The automatic roller shutter for animals according to claim 1, wherein the front housing comprises a front cover and a bottom plate, the bottom plate is fixed on the front side of the upper end of the door frame; the accumulator, the controller and the display screen are arranged on the bottom plate, and the front cover is covered in front of the bottom plate.

10. The automatic roller shutter for animals according to claim 9, wherein the front cover comprises an outer housing and an inner housing arranged in an integrated form with the outer housing, and an internal space is defined by the bottom plate and the inner housing for receiving the accumulator, the controller and the display screen.

11. The automatic roller shutter for animals according to claim 10, wherein an isolation groove is formed between the inner housing and the outer housing, and a reinforcing rib connecting with the inner housing and the outer housing is provided in the isolation groove.

12. The automatic roller shutter for animals according to claim 10, wherein an inner wall of the inner housing is extended inward to from a support plate, on which the accumulator is arranged.

13. The automatic roller shutter for animals according to claim 9, wherein a plurality of connecting members are extended inward from the front cover, a plurality of connecting holes corresponding to the connecting members are provided on an outer side of the bottom plate, and the bottom plate is fixed and connected with the front cover by screws passing through the connecting holes and center holes of the connecting members.
